(19) United States
(12) Patent Application Publication
(10) Pub. No.: US 2023/0097989 A1
(43) Pub. Date: Mar. 30, 2023

(54) REQUIRED INVENTORY CALCULATING SYSTEM

(71) Applicant: DISCO CORPORATION, Tokyo (JP)

(72) Inventors: Hirotoshi HOSHIKAWA, Tokyo (JP); Tomoharu KIHARA, Tokyo (JP); Shigehiko AOKI, Tokyo (JP); Tomohiro CHISAKA, Tokyo (JP); Takahiro YOSHIMURA, Tokyo (JP); Akihiro SHIMATANI, Tokyo (JP); Souichi SHINTANI, Tokyo (JP); Yasuyuki INOUE, Tokyo (JP); Syota FUJIMI, Tokyo (JP); Kazuaki NISHIMURA, Tokyo (JP); Takashi NAKAHARA, Tokyo (JP)

(21) Appl. No.: 17/932,714

(22) Filed: Sep. 16, 2022

(30) Foreign Application Priority Data
Sep. 27, 2021 (JP) 2021-157074

(51) Int. Cl. G06Q 10/08; G06Q 30/02

(52) U.S. Cl. CPC G06Q 10/087; G06Q 30/0202

(57) ABSTRACT

A required inventory calculating system includes a first section for calculating product importance level coefficients, a second section for calculating procurement risk level coefficients, a third section for calculating general coefficients by multiplying the product importance level coefficients by the procurement risk level coefficients, a fourth section for calculating required inventory periods respectively with respect to raw materials or partly finished products by multiplying the general coefficients by a predetermined longest inventory period, and, if the required inventory periods are shorter than a predetermined shortest inventory period, setting the required inventory periods as the shortest inventory period, and a fifth section for calculating required inventories respectively for the raw materials or the partly finished products by multiplying required quantities of the raw materials or the partly finished products required to supply the products to customers or wholesalers in a predetermined period by the respective required inventory periods.

### BACKGROUND OF THE INVENTION

### Field of the Invention

The present invention relates to a required inventory calculating system for calculating appropriate required inventories of raw materials or partly finished products to be procured from one or more suppliers and added to a stock of a product supplier amidst commercial activities of the product supplier to procure at least either raw materials or partly finished products from the one or more suppliers, manufacture products therefrom, and supply the products to customers or wholesalers.

### Description of the Related Art

Product suppliers such as makers, i.e., product manufacturers, procure raw materials and partly finished products from one or more suppliers, manufacture products from the procured raw materials and partly finished products, and sell the products to customers or wholesalers via logistics providers. While engaging the various operations, the product manufacturers establish links with various firms such as suppliers or logistics providers. The sequence of processes including the procurement of raw materials and partly finished products, the fabrication of products, the inventory management for raw materials and partly finished products, the distribution and sale of products, etc. is referred to as “supply chain.”

For making the supply chain more efficient, it is known at present in the art to perform supply chain management (SCM) using a supply chain model established on a computer (see, for example, JP 2009-75919A). However, even though the SCM allows a product supplier to manage the number of products to be manufactured, the delivery dates thereof, the inventory of raw materials and partly finished products, and other data appropriately at normal times, the supply chain between the suppliers and the product suppliers may be disrupted in emergency situations such as earthquakes and floods that are difficult to quantify in terms of frequency of occurrence and unable to control deliberately.

Product suppliers are required to manage the inventory of raw materials and partly finished products appropriately, for example, in order to supply products stably to customers or wholesalers not only at ordinary times but also in case of emergency. However, if product suppliers manufacture a wide range of products and deal with many domestic and overseas suppliers, then it is not easy to decide which raw materials and partly finished products for which products are to be kept preferentially in inventory.

Specifically, it is difficult to decide, with respect to suppliers in various countries of the world, which raw materials and partly finished products for which products are to be kept preferentially in inventory and how much the stock of raw materials and partly finished products is to be adjusted in view of the laws, state of affairs, geographical risks, etc. in the countries in case of emergency. In addition, when workers of product suppliers are to determine the inventory of raw materials and partly finished products required to manufacture each product, the workers need to spend an enormous number of man-hours, i.e., a working time multiplied by the number of persons working to determine the inventory, resulting in a costly process.

### SUMMARY OF THE INVENTION

The present invention has been made in view of the above problems. It is an object of the present invention to provide a required inventory calculating system for calculating a required inventory of raw materials, etc. required by a product supplier for stably supplying products, less costly in a smaller number of man-hours than if a worker determines the inventory.

In accordance with an aspect of the present invention, there is provided a required inventory calculating system for calculating appropriate required inventories of raw materials or partly finished products to be procured from one or more suppliers and added to stock of a product supplier amidst commercial activities of the product supplier to procure at least either the raw materials or the partly finished products from the one or more suppliers, manufacture products therefrom, and supply the products to customers or wholesalers. The required inventory calculating system includes a memory storing names of the products, names of the raw materials or the partly finished products from which the products are manufactured, names of the one or more suppliers that supply the raw materials or the partly finished products, and required quantities of the raw materials or the partly finished products required to supply the products to the customers or the wholesalers in a predetermined period. The required inventory calculating system further includes a processor, a product importance level coefficient calculating section for calculating product importance level coefficients established depending on an extent to which the products are needed by the customers or the wholesalers and representing respective levels of importance of the products, a procurement risk level coefficient calculating section for calculating procurement risk level coefficients, respectively with respect to the raw materials or the partly finished products, established depending on a risk that the product supplier may not be able to procure the raw materials or the partly finished products from the one or more suppliers and representing the respective levels of procurement risk of the raw materials or the partly finished products, a general coefficient calculating section for calculating general coefficients normalized such that their maximum value is 1 by multiplying the product importance level coefficients by the procurement risk level coefficients respectively with respect to the raw materials or the partly finished products, a required inventory period calculating section for calculating required inventory periods respectively with respect to the raw materials or the partly finished products by multiplying the general coefficients by a predetermined longest inventory period, and, if the calculated required inventory periods are shorter than a predetermined shortest inventory period, setting the calculated required inventory periods as the shortest inventory period, and a required inventory calculating section for calculating required inventories respectively for the raw materials or the partly finished products by multiplying the required quantities of the raw materials or the partly finished products in the predetermined period by the respective calculated required inventory periods.

Preferably, the product importance level coefficients are established such that the larger the quantities sold of the products in the predetermined period are, the higher numerical values represented by the product importance level coefficients are.

Preferably, the product importance level coefficients include actual price coefficients, and the actual price coefficients are established such that the higher an average value of actual prices of the products in the predetermined period is or the lower a discount ratio of the actual prices is, the higher the actual price coefficients are.

Preferably, the procurement risk level coefficients are calculated depending on risks of natural disasters at locations of places where the suppliers manufacture the raw materials or the partly finished products or places where the suppliers store the raw materials or the partly finished products.

Preferably, the procurement risk level coefficients are calculated in view of geographical factors of the suppliers including world risk indexes of a world risk report about countries of places where the suppliers manufacture the raw materials or the partly finished products or places where the suppliers store the raw materials or the partly finished products and information as to whether or not there is a nuclear power plant in the locations of the places where the suppliers manufacture the raw materials or the partly finished products or places where the suppliers store the raw materials or the partly finished products.

In accordance with another aspect of the present invention, there is provided a program stored in a medium readable by a computer for enabling the computer, in calculating appropriate required inventories of raw materials or partly finished products to be procured from one or more suppliers and added to stock of a product supplier amidst commercial activities of the product supplier to procure at least either the raw materials or the partly finished products from the one or more suppliers, manufacture products therefrom, and supply the products to customers or wholesalers. The program includes calculating product importance level coefficients established depending on an extent to which the products are needed by the customers or the wholesalers and representing respective levels of importance of the products, calculating procurement risk level coefficients, respectively with respect to the raw materials or the partly finished products, established depending on a risk that the product supplier may not be able to procure the raw materials or the partly finished products from the one or more suppliers and representing the respective levels of procurement risk of the raw materials or the partly finished products, calculating general coefficients normalized such that their maximum value is 1 by multiplying the product importance level coefficients by the procurement risk level coefficients respectively with respect to the raw materials or the partly finished products, calculating required inventory periods respectively with respect to the raw materials or the partly finished products by multiplying the general coefficients by a predetermined longest inventory period, and, if the calculated required inventory periods are shorter than a predetermined shortest inventory period, setting the calculated required inventory periods as the shortest inventory period, and calculating required inventories respectively for the raw materials or the partly finished products by multiplying the required quantities of the raw materials or the partly finished products in the predetermined period by the respective calculated required inventory periods.

Since the required inventory calculating system according to the aspect of the present invention automatically calculates required inventories of raw materials or partly finished products in a predetermined period, the required inventories that are required by a product supplier in the predetermined period to supply products stably can be calculated with a smaller number of man-hours than if they are determined by a worker of the product supplier. Therefore, the required inventories of the raw materials or the partly finished products can be calculated less costly than if they are determined by a worker of the product supplier. Similarly, since the program according to the aspect of the present invention enables the computer to automatically calculate required inventories, the program allows the required inventories to be calculated in smaller number of man-hours and less costly than if they are determined by a worker of the product supplier.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a block diagram of a required inventory calculating system according to a first embodiment of the present invention;

FIG. 2 is a block diagram illustrating commercial activities of a product supplier;

FIG. 3 is a diagram illustrating an example of correlation between products, raw materials, and partly finished products;

FIG. 4 is a diagram illustrating product importance level coefficients;

FIG. 5 is a flowchart of a sequence for calculating a product importance level coefficient;

FIG. 6 is a diagram illustrating total numbers of points of procurement risks taking internal factors into account;

FIG. 7 is a diagram illustrating total numbers of points of procurement risks taking geographical factors into account;

FIG. 8 is a diagram illustrating proportions of World Risk Indexes (WRI) of World Risk Report (WRR), nuclear power plants, and natural disaster totals in the total numbers of points of procurement risks representing geographical factors;

FIG. 9 is a diagram illustrating procurement risk level coefficients;

FIG. 10 is a flowchart of a sequence for calculating a procurement risk level coefficient;

FIG. 11 is a diagram illustrating required inventories;

FIG. 12 is a flowchart of a sequence for calculating a required inventory;

FIG. 13 is a block diagram of a required inventory calculating system according to a second embodiment of the present invention;

FIG. 14A is a block diagram of a required inventory calculating system according to a third embodiment of the present invention; and

FIG. 14B is a block diagram of a required inventory calculating system according to a fourth embodiment of the present invention.

### DETAILED DESCRIPTION OF THE PREFERRED EMBODIMENTS

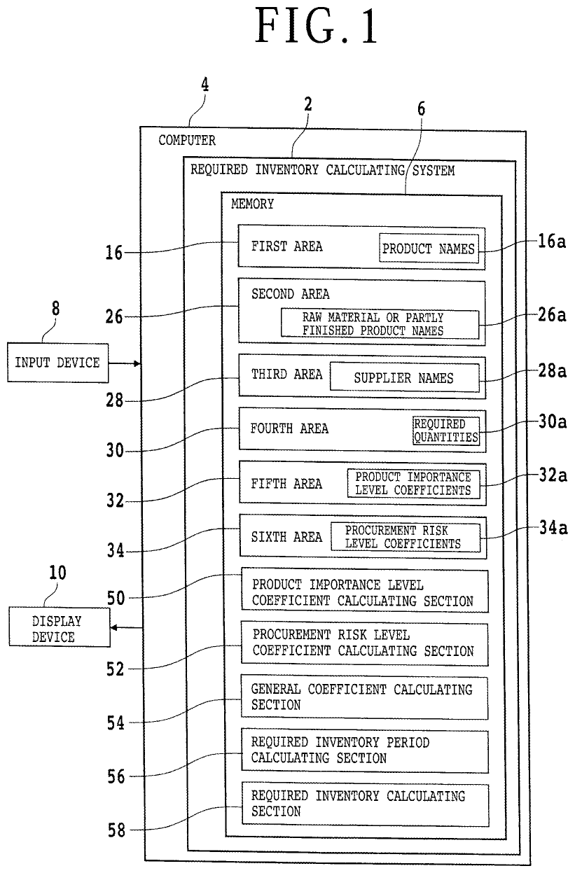

Preferred embodiments of the present invention will be described hereinbelow with reference to the accompanying drawings. FIG. 1 illustrates in block form a required inventory calculating system 2 according to a first embodiment of the present invention. As illustrated in FIG. 1, the required inventory calculating system 2 is configured in a stand-alone computer 4 that is not connected to other computers through a network. The computer 4 with the required inventory calculating system 2 configured therein includes a desktop or laptop computer, i.e., a personal computer, or a server. However, as described later, the required inventory calculating system 2 may be downloaded to the computer 4 in the form of software as a service (SaaS) from a server via the Internet.

The computer 4 includes a processor, i.e., a processing device, not depicted, typically a central processing unit (CPU), and a memory, i.e., storage device, 6, for example. The memory 6 includes a main storage unit such as a dynamic random access memory (DRAM), a static random access memory (SRAM), or a read only memory (ROM), and an auxiliary storage unit such as a flash memory, a hard disk drive, or a solid state drive. The auxiliary storage unit stores software including predetermined programs. When the processing device, etc. are operated according to the software, the required inventory calculating system 2 has its functions performed.

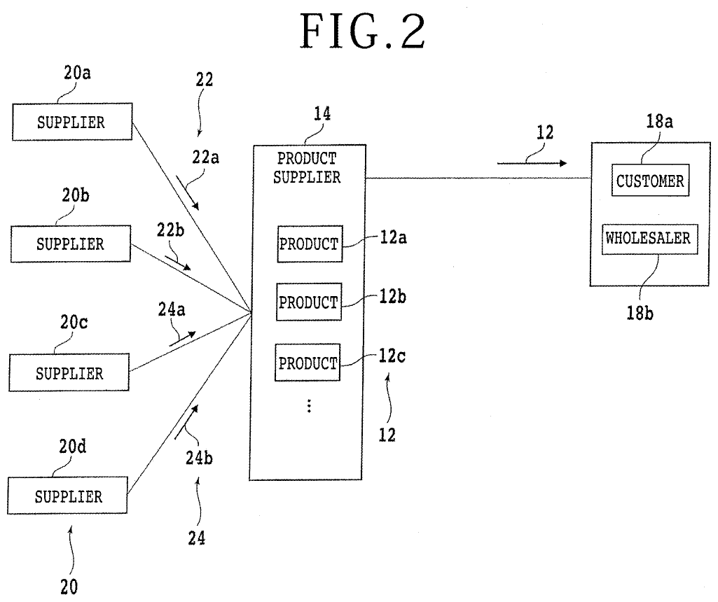

As illustrated in FIG. 1, an input device 8 that acts as an interface to be used by a worker of a product supplier 14 (see FIG. 2) to enter information into the computer 4 is electrically connected to the computer 4. The input device 8 preferably, but not necessarily, include a keyboard, a mouse, or a reader for a recording medium, for example. The recording medium includes a universal serial bus (USB) memory or a digital versatile disc (DVD), for example, though it is not limited to such examples, but may be any of other recording mediums.

In addition to the input device 8, a display device 10 is also electrically connected to the computer 4. Whereas the input device 8 is used to enter information into the computer 4, the display device 10 is used to display the results of processing operations performed by the computer 4. The display device 10 may include a touch panel having the function of the input device 8. In case the display device 10 includes a touch panel, the input device 8 may be dispensed with.

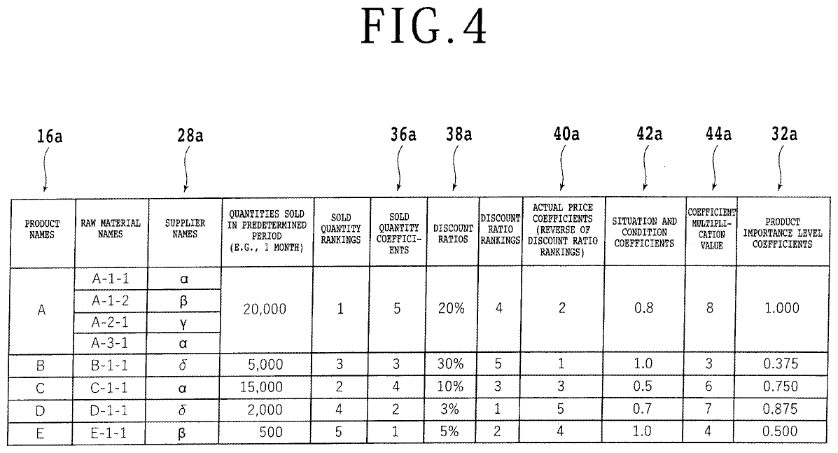

Part of the memory 6, e.g., part of the auxiliary storage unit, has a first area 16 for storing the names of products 12 (see FIG. 2), i.e., product names 16a (see FIG. 4, for example). The products 12 and other details will be described below with reference to FIG. 2. FIG. 2 illustrates in block form commercial activities of the product supplier 14. The product supplier 14 is a main entity that manufactures products 12 and sells, i.e., supplies, the products 12 to a customer 18a or a wholesaler 18b, and is also called “maker” or “product manufacturer.”

According to the present embodiment, the product supplier 14 is a judicial person. In the present description, a natural person such as an employer or an employee of the product supplier 14 as the judicial person is referred to as a “worker.” The product supplier 14 procures at least either raw materials 22 or partly finished products 24 from one or more suppliers 20, and manufactures products 12 therefrom. For example, the product supplier 14 procures a raw material 22a from a supplier 20a, a raw material 22b from a supplier 20b, a partly finished product 24a from a supplier 20c, and a partly finisher product 24b from a supplier 20d, and manufactures a product 12a. However, the product supplier 14 may procure the raw material 22a from the supplier 20a and manufacture another product 12b, or may procure the partly finished product 24a from the supplier 20c and manufacture another product 12c.

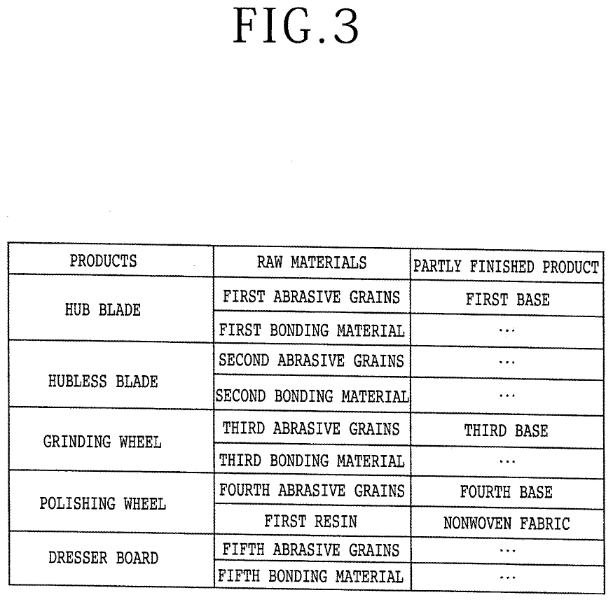

The examples illustrated in FIG. 2 are simple for illustrative purposes. According to other examples, the product supplier 14 may procure the raw materials 22a and 22b from the supplier 20a and may procure the partly finished products 24a and 24b from the supplier 20a. The product supplier 14 may procure the raw material 22a and the partly finished product 24a from the supplier 20a. One of the products 12 includes a hub blade (see FIG. 3), for example. The hub blade has an annular base, i.e., a hub, made of aluminum alloy and an annular cutting edge fixed to an outer circumferential portion of one surface of the base.

FIG. 3 illustrates an example of correlation between the products 12, the raw materials 22, and the partly finished products 24. The hub blade is fabricated from first abrasive grains and a first bonding material that make up the cutting edge, and the first base, for example. To manufacture the hub blade, any of other raw materials 22 or partly finished products 24 may additionally be used. Another one of the products 12 includes a hubless blade, also called “washer blade,” for example. The hubless blade is free of a base and includes an annular cutting edge only. The hubless blade is fabricated from second abrasive grains and a second bonding material, for example. To manufacture the hubless blade, any of other raw materials 22 or partly finished products 24 may additionally be used.

Still another one of the products 12 includes a grinding wheel, for example. The grinding wheel has an annular third base made of metal and a plurality of grindstones disposed on one surface of the third base and spaced at substantially equal intervals in circumferential directions of the third base. Each of the grindstones is fabricated by mixing third abrasive grains with a third bonding material, molding the mixture, and then sintering the mixture. To manufacture the grinding wheel, any of other raw materials 22 or partly finished products 24 may additionally be used.

Yet another one of the products 12 includes a polishing wheel, for example. The polishing wheel has an annular fourth base made of metal and an annular polishing pad disposed on one surface of the fourth base. To manufacture the polishing wheel, any of other raw materials 22 or partly finished products 24 may additionally be used. A still further one of the products 12 includes a dresser board also called “dressing board.” The dresser board is manufactured by mixing fifth abrasive grains with a fifth bonding material, molding the mixture, and then sintering the mixture, for example. To manufacture the dresser board, any of other raw materials 22 or partly finished products 24 may additionally be used.

Processing tools such as hub blades, hubless blades, grinding wheels, or polishing wheels, and dresser boards are expendables used in a semiconductor fabrication apparatus such as a cutting apparatus, a grinding apparatus, or a polishing apparatus. If supply chains for supplying such expendables for use in the semiconductor fabrication apparatus from product suppliers 14 to customers 18a or wholesalers 18b are disrupted, then the fabrication of semiconductor chips is adversely affected, resulting in a global delay in the fabrication and distribution of various commercial products including mobile phones, personal computers, automobiles, etc.

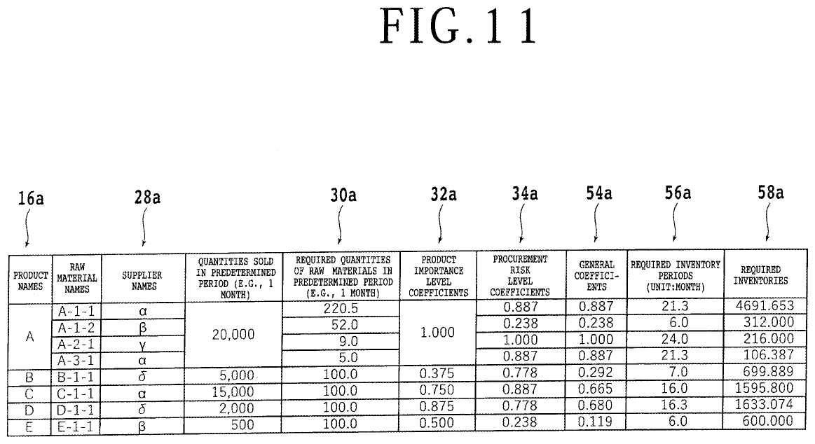

According to the present embodiment, the supply of products 12 is managed using the required inventory calculating system 2 amidst commercial activities of the product supplier 14 in the supply chains from the procurement to sale of the products 12. Specifically, appropriate required inventories 58a (see FIG. 11) of raw materials 22 and partly finished products 24 in the product supplier 14 are calculated using the required inventory calculating system 2.

As illustrated in FIG. 1, the memory 6 has a second area 26. The second area 26 stores the names of raw materials 22 or partly finished products 24, i.e., raw material or partly finished product names 26a, to be used in the products 12. The memory 6 further has a third area 28. The third area 28 stores the names of one or more suppliers 20, i.e., one or more supplier names 28a, that supply raw materials 22 or partly finished products 24.

The memory 6 also includes a fourth area 30. The fourth area 30 stores required quantities 30a (see FIG. 11) of raw materials 22 or partly finished products 24 required to supply products 12 to customers 18a or wholesalers 18b in a predetermined period, i.e., one month according to the present embodiment. The required quantities 30a of at least either raw materials 22 or partly finished products 24 required to manufacture products 12 are calculated on the basis of an average value per month of quantities sold of the respective products 12 in a duration of the last 6 to 12 months prior to the time when the required inventories 58a are calculated. Since irregular quantities sold in slack and busy periods can be evened out by using the average value per month of the quantities sold of the products 12 in the duration of the last 6 to 12 months, the required quantities 30a and the required inventories 58a can be calculated more adequately than if the average value is not used.

The memory 6 further includes a fifth area 32. The fifth area 32 stores product importance level coefficients 32a. A product importance level coefficient 32a is established depending on the extent to which a product 12 is needed by the customer 18a or the wholesaler 18b, and represents the level of importance of the product 12. The product importance level coefficient 32a is calculated by a product importance level coefficient calculating section 50.

The product importance level coefficient 32a will be described hereinbelow with reference to FIG. 4. FIG. 4 illustrates product importance level coefficients 32a. A table illustrated in FIG. 4 lists in its uppermost field, successively from the left, “PRODUCT NAME,” “RAW MATERIAL NAME,” “SUPPLIER NAME,” “QUANTITY SOLD IN GIVEN PERIOD,” “SOLD QUANTITY RANKINGS,” “SOLD QUANTITY COEFFICIENT,” “DISCOUNT RATIO,” “DISCOUNT RATIO RANKINGS,” “ACTUAL PRICE COEFFICIENT,” “SITUATION AND CONDITION COEFFICIENT,” “COEFFICIENT MULTIPLICATION VALUE,” and “PRODUCT IMPORTANCE LEVEL COEFFICIENT.”

Product names 16a are listed in a leftmost column of the table in FIG. 4. In FIG. 4, the product names 16a are represented by A, B, C, D, and E for illustrative purposes. The names of raw materials 22 in the raw material or the partly finished product names 26a relative to the product names 16a are listed in a next column on the right side of the column of the product names 16a. The product 12 of A is associated with four raw materials 22, i.e., A-1-1, A-1-2, A-2-1, A-3-1, though other raw materials 22 and partly finished products 24 are omitted for illustrative purposes.

The respective products 12 of B, C, D, and E have in common one kind of the raw materials 22, i.e., B-1-1, C-1-1, D-1-1, E-1-1, though other raw materials 22 and partly finished products 24 are omitted for illustrative purposes. Numerals following the alphabetical letters represent identification codes for the raw materials 22. For example, “1-1” in A-1-1, B 1, C-1-1, D-1-1, E-1-1 indicate the same raw material 22. “1-1” represents abrasive grains having a predetermined level of granularity, for example.

A plurality of suppliers 20 are listed in a next column on the right side of the column of the raw material names 26a. In FIG. 4, four different companies represented by a, R, y, and 5 are listed as the suppliers 20. FIG. 4 depicts that the product supplier 14 procures the raw materials 22 indicated by the identification code “1-1” from the three companies a, R, and 5, not one company. The sold quantity rankings refer to rankings of average values per month of quantities sold of the respective products 12 in the duration of the last 6 to 12 months. The product 12 of A whose sold quantity is the greatest has a ranking 1, and the product 12 of E whose sold quantity is the smallest has a ranking 5.

The larger the sold quantity of a product 12 is, the higher its importance is considered to be, as the product 12 is more required by customers 18a and wholesalers 18b. By reflecting a sold quantity coefficient 36a of the product 12 finally in the product importance level coefficient 32a thereof, the degree of demand for the product 12 from customers 18a and wholesalers 18b can be reflected in the product importance level coefficient 32a. The sold quantity coefficient 36a is established such that the larger the sold quantity of the product 12 in a predetermined period is, the higher the numerical value of the sold quantity coefficient 36a is. In the example illustrated in FIG. 4, since five kinds of products 12 are illustrated, the sold quantity coefficient 36a is defined in five steps. However, the sold quantity coefficient 36a may be defined in desired steps depending on the kinds of products 12 supplied from the product supplier 14. For example, if the product supplier 14 supplies 50 or 100 kinds of products 12, then the sold quantity coefficient 36a may be defined in 50 or 100 steps.

A discount ratio 38a represents a numerical value indicating the ratio of a desired retail price offered by the product supplier 14 for a product 12 and the difference between the desired retail price and the price of the product 12 actually purchased by a customer 18a or a wholesaler 18b, i.e., an actual price. In FIG. 4, the discount ratios 38a are indicated by a percentage. In case a desired retail price is constant for a predetermined period, for example, a discount ratio 38a is obtained by dividing the difference between the desired retail price and the actual price by an average value of actual prices of the products 12 in the predetermined period and then multiplying the quotient by 100. In case the desired retail price varies in the predetermined period, the variation may suitably be reflected in the discount ratio 38a.

A discount ratio 38a is finally reflected in a product importance level coefficient 32a. The lower the discount ratio 38a of a product 12 is, the higher its importance is considered to be, as the product 12 is more required by customers 18a and wholesalers 18b. By reflecting the discount ratio 38a of the product 12 finally in the product importance level coefficient 32a thereof, the degree of demand for the product 12 from customers 18a and wholesalers 18b can be reflected in the product importance level coefficient 32a. According to the present embodiment, rankings that are the reverse of the rankings of discount ratios 38a are determined to be actual price coefficients 40a. Therefore, the actual price coefficient 40a is established such that the lower the discount ratio 38a is, the higher the actual price coefficient 40a is. Stated otherwise, the higher the actual price is, the higher the actual price coefficient 40a is.

In the example illustrated in FIG. 4, since five kinds of products 12 are illustrated, the discount ratio 38a is defined in five steps. Consequently, the actual price coefficient 40a is also defined in five steps. Specifically, the product 12 of D whose discount ratio 38a has a ranking 1 has an actual price coefficient 40a of 5 that is the reverse of the ranking 1 of the discount ratio 38a. Similarly, the product 12 of B whose discount ratio 38a has a ranking 5 has an actual price coefficient 40a of 1 that is the reverse of the ranking 5 of the discount ratio 38a. However, an actual price coefficient 40a may be determined appropriately depending on the kinds of products 12 supplied by the product supplier 14. For example, if the product supplier 14 supplies 50 or 100 kinds of products 12, then the actual price coefficient 40a may be defined in 50 or 100 steps.

A situation and condition coefficient 42a represents a numerical value set by the worker of the product supplier 14 depending on the circumstances in which raw materials 22 and partly finished products 24 are procured. For example, in case a raw material 22 is procured from a plurality of suppliers 20, since the risk that the raw material 22 cannot be procured is considered to be relatively low, the situation and condition coefficient 42a is set to a relatively small value. By contrast, in case a raw material 22 is procured from one supplier 20 only, since the risk that the raw material 22 cannot be procured is considered to be relatively high, the situation and condition coefficient 42a is set to 1.0 (maximum value).

The products 12 of B and E in FIG. 4 have respective situation and condition coefficients 42a of 1.0 because they are affected by other raw materials 22 and partly finished products 24 (not depicted) than the raw material 22 identified by the identification code “1-1.” However, as the situation and condition coefficients 42a are coefficients selectively set in calculating product importance level coefficients 32a, the situation and condition coefficients 42a themselves may be omitted.

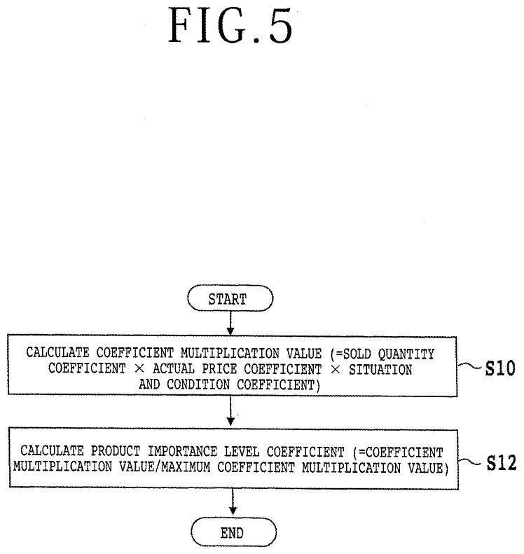

The product of a sold quantity coefficient 36a, an actual price coefficient 40a, and a situation and condition coefficient 42a represents a coefficient multiplication value 44a (S10 in FIG. 5). FIG. 5 is a flowchart of a sequence for calculating a product importance level coefficient 32a. The coefficient multiplication value 44a of the product 12 of A is 8 (=5×2×0.8), and the coefficient multiplication value 44a of the product 12 of B is 3 (=3×1×1.0). The coefficient multiplication value 44a of the product 12 of C is 6 (=4×3×0.5), and the coefficient multiplication value 44a of the product 12 of D is 7 (=2×5×0.7). The coefficient multiplication value 44a of the product 12 of E is 4 (=1×4×1.0).

According to the present embodiment, a value obtained by dividing a coefficient multiplication value 44a by the maximum value of a plurality of coefficient multiplication values 44a represents a product importance level coefficient 32a (S12 in FIG. 5). In the example illustrated in FIG. 4, since the maximum coefficient multiplication value 44a is “8” with respect to the product 12 of A, the product importance level coefficients 32a of the products 12 are calculated by dividing the respective coefficient multiplication values 44a by “8.” As illustrated in FIG. 4, the product importance level coefficients 32a of the products 12 of A through E are calculated as 1.000 (=8/8), 0.375 (=⅜), 0.750 (= 6/8), 0.875 (=⅞), and 0.500 ( 4/8), respectively. In this manner, the product importance level coefficients 32a normalized such that their maximum value is 1 are calculated respectively with respect to the products 12.

As illustrated in FIG. 1, the predetermined programs that are executed by the processor function as the required inventory calculating system 2. The required inventory calculating system 2 has the product importance level coefficient calculating section 50. The product importance level coefficient calculating section 50 is implemented by a first program read from the memory 6 and executed by the processor, for example. The product importance level coefficient calculating section 50 calculates product importance level coefficients 32a in the above manner based on quantities sold, desired retain prices and actual prices (or discount ratios 38a), and situation and condition coefficients 42a. The product importance level coefficients 32a calculated respectively with respect to the products 12 are stored in the fifth area 32 of the memory 6.

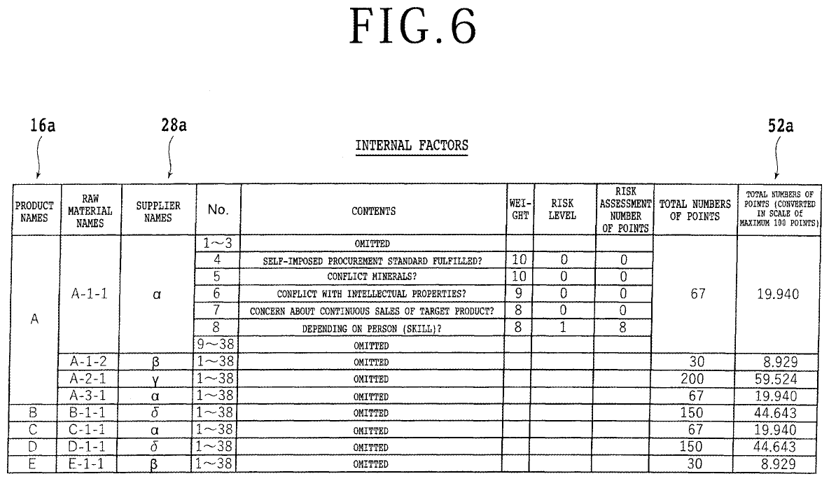

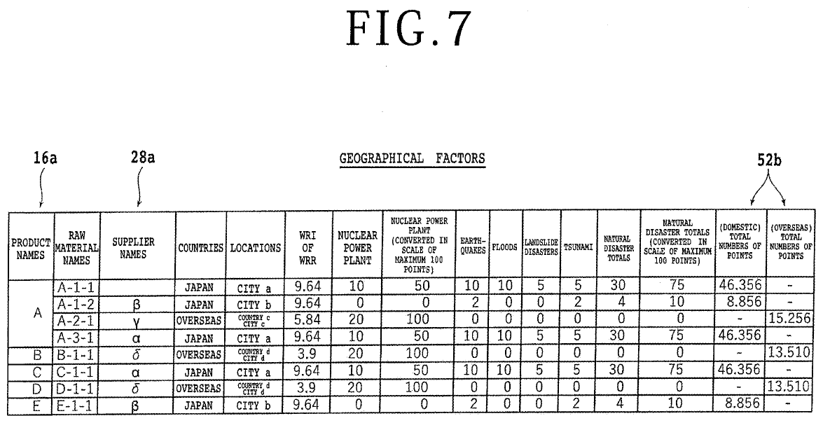

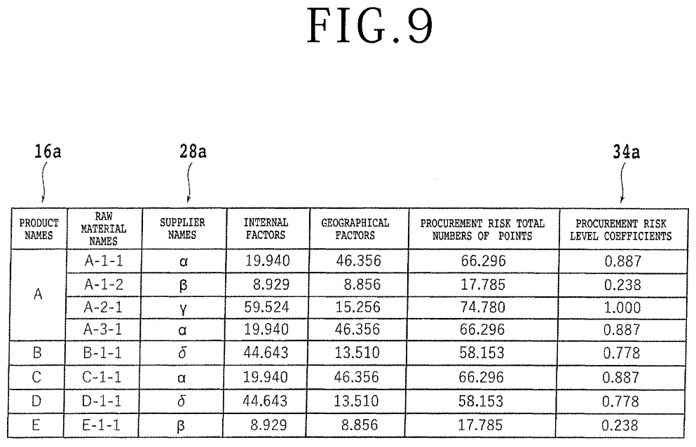

Procurement risk level coefficients 34a (see FIG. 9) will be described below with reference to FIGS. 6 through 10. Procurement risk level coefficients 34a are calculated by a procurement risk level coefficient calculating section 52 illustrated in FIG. 1. A procurement risk level coefficient 34a represents a level of risk that a raw material 22 or a partly finished product 24 may not be procured, i.e., a procurement risk, when the product supplier 14 is to procure raw materials 22 or partly finished products 24 from the suppliers 20. Procurement risk level coefficients 34a are established depending on the risk that the product supplier 14 may not be able to procure raw materials 22 or partly finished products 24 from one or more suppliers 20, and include internal factors (see FIG. 6) of the suppliers 20 and geographical factors (see FIG. 7) of the suppliers 20.

FIG. 6 illustrates total numbers of points 52a of procurement risks taking internal factors of the suppliers 20 into account. In FIG. 6, product names 16a are listed in a leftmost column of the illustrated table, as with FIG. 4. Partly finished products 24 are omitted from FIG. 6 for illustrative purposes. Product names 16a, raw material names, and supplier names 28a are identical to those illustrated in FIG. 4. A column on the right side of the column of the supplier names 28a lists Nos. A column on the right side of the column of the Nos. lists specific contents of the Nos. 1 through 38. In FIG. 6, only specific contents of the Nos. 4 through 8 are listed, and other specific contents of the Nos. 1 through 3 and 9 through 38 are omitted from illustration, as indicated by “omitted.”

The specific contents of No. 4 are indicative of whether the raw material 22 fulfils a self-imposed procurement standard of the product supplier 14 or not. According to the present embodiment, the self-imposed procurement standard of the product supplier 14 is a standard as to whether raw materials 22 procured from the supplier(s) 20 by the product supplier 14 have a small environmental footprint or not. The procurement of raw materials 22 complying with such a standard is called “green procurement.” The specific contents of No. 5 are indicative of whether the raw material 22 contains conflict minerals or not. The specific contents of No. 6 are indicative of whether the raw material 22 conflicts with intellectual properties such as patents or not.

The specific contents of No. 7 are indicative of whether there is a concern about continuous sales of the raw material 22 or not. The specific contents of No. 8 are indicative of whether the production of the raw material 22 hinges upon a natural person of the supplier(s) 20, e.g., the skill, the ability, or the like of a natural person, or not. A column on the right side of the column of the contents lists weights represented by natural numbers ranging from 1 to 10. These weights are assigned numerals such that the higher the possibility that the product supplier 14 may be unable to procure raw materials 22 from the suppliers 20 is, the larger the numerals are.

For example, if the raw material 22 falls into Nos. 4 and 5, then the product supplier 20 can never procure the raw material 22, and the weight is set to 10. In contrast, if the raw material 22 falls into No. 6, then since the product supplier 20 may possibly be able to procure the raw material 22 by taking out a contract for an amicable settlement, the weight is set to 9 lower than 10. Furthermore, if the raw material 22 falls into Nos. 7 and 8, then since the product supplier 20 can procure the raw material 22 from another supplier 20, the weight is set to 8 lower than 9. The numbers of points indicating the weights are reviewed and updated accordingly by a worker of the product supplier 14.

A column on the right side of the column of the weights lists levels of risk. The levels of risk represent how high is the possibility that the suppliers 20 will fall into the contents of Nos. 1 through 38, and are set to three steps represented by numerals 0, 1, and 2 according to the present embodiment. The levels of risk are established when the procurement risk level coefficients 34a are calculated, for example.

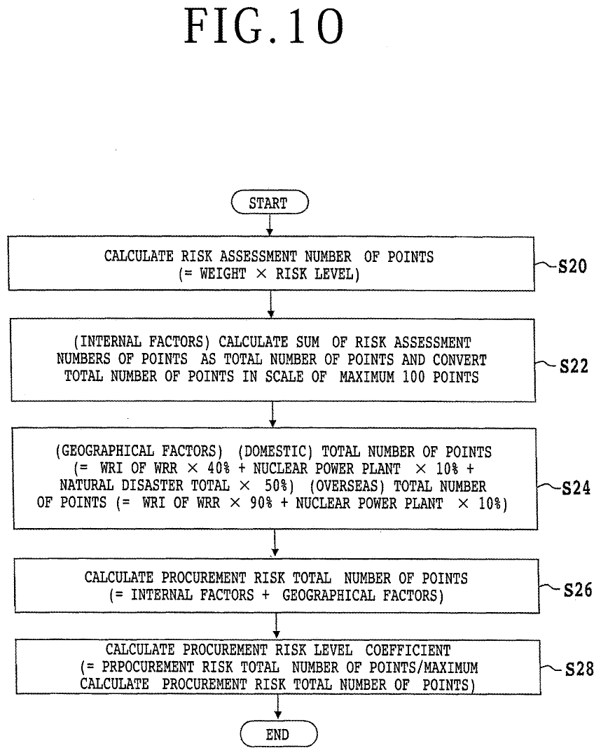

According to the present embodiment, a worker of the product supplier 14 determines or assesses the possibility that the suppliers 20 will fall into the contents of Nos. 1 through 38, on the basis of information supplied from the suppliers 20 such as answers from the suppliers 20 to a questionnaire given from the product supplier 14 to the suppliers 20. Specifically, if the possibility is high, e.g., if the possibility is in excess of 50%, then the level of risk is set to 2. If the possibility is neither high nor zero, e.g., if the possibility is higher than 0%, but equal to or lower than 50%, then the level of risk is set to 1. If the possibility is none, i.e., 0%, then the level of risk is set to 0. The product of a weight and a level of risk represents a risk assessment number of points (S20 in FIG. 10). Risk assessment numbers of points are similarly calculated respectively with respect to Nos. 1 through 38, and total risk assessment numbers of points are calculated respectively with respect to the raw material names. According to the present embodiment, the maximum value of the total numbers of points is preset to 336. The total number of points for A-1-1 is 67.

According to the present embodiment, after the total number of points has been divided by 336 with respect to each of the raw material names, the quotient is multiplied by 100, thereby calculating a total number of points 52a as converted in a scale of maximum 100 points (S22 in FIG. 10). In the example illustrated in FIG. 6, the total number of points is 19.940 with respect to A-1-1, A-3-1, and C-1-1 (the supplier name 28a is α). In contrast, the total number of points is 8.929 with respect to A-1-2 and E-1-1 (the supplier name 28a is β). The total number of points is 59.524 with respect to A-2-1 (the supplier name 28a is γ). The total number of points is 44.643 with respect to B-1-1 and D-1-1 (the supplier name 28a is δ).

FIG. 7 illustrates total numbers of points 52b of procurement risks taking geographical factors of the suppliers 20 into account. In FIG. 7, product names 16a are listed in a leftmost column of the illustrated table, as with FIG. 4. Partly finished products 24 are omitted from FIG. 7 for illustrative purposes. Product names 16a, raw material names, and supplier names 28a are identical to those illustrated in FIG. 4. Note that the partly finished products 24 are omitted for convenience. Two columns on the right side of the column of the supplier names 28a list countries and locations, respectively, of places where the suppliers 20 have fabricated raw materials 22 or partly finished products 24, i.e., fabrication places, or places where raw materials 22 or partly finished products 24 fabricated by the suppliers 20 are stored, i.e., “storage places.” Foreign countries other than Japan are simply indicated as overseas in the column of countries and listed in the column of locations.

A column on the right side of the column of the countries and the locations lists WRI of WRR about the countries of the places where the raw materials 22 or partly finished products 24 have been fabricated or the places where the raw materials 22 or partly finished products 24 are stored. WRR is published every year from 2011 on. For the 2020 edition of WRR, reference should be made to the following link in parentheses. (https://reliefweb.int/sites/reliefweb.int/files/resource s/WorldRiskReport-2020.pdf)

According to WRR, indexes assessing risks such as natural disasters are given as WRI for the respective countries. WRI represents a number of points up to 100. According to the present embodiment, latest WRI at the time total numbers of points 52b are calculated are used. A column on the right side of the column of the WRR lists numbers of points as to whether there is a nuclear power plant or not. For example, in case the location of a fabrication place or a storage place is within a circle having a radius of 20 km with a nuclear power plant at its center, 20 points are given. In case the location is not within a circle having a radius of 20 km, but within a circle having a radius of 30 km, 10 points are given. In case the location is outside a circle having a radius of 30 km, no points are given.

The numbers of points as to whether there is a nuclear power plant or not are converted in a scale of maximum 100 points and listed in a column on the right side of the column of the numbers of points as to whether there is a nuclear power plant or not. A column on the right side of the column of the converted numbers of points lists numbers of points depending on risks that earthquakes, floods, landslide disasters, and tsunami, i.e., natural disasters.

Inasmuch as it is difficult to assess natural disasters in other countries than Japan according to a scale used in Japan, only the suppliers 20 whose fabrication places and storage places, i.e., their locations are in Japan are to be assessed with respect to earthquakes, floods, landslide disasters, and tsunami. Numbers of points about earthquakes, floods, landslide disasters, and tsunami are listed in a scale of maximum 10 points. Numbers of points about earthquakes are calculated using “probability that places will be hit by earthquakes” provided as J-SHIS Map (http://www.j-shis.bosai./go./jp/map/) at J-SHIS (Japan Seismic Hazard Information Station), for example.

According to the present embodiment, the probability that the locations of fabrication places or storage places will be hit by earthquakes having a seismic intensity of a lower 6 or higher in 30 years to come is converted in a scale of maximum 10 points. For example, the probability ranging from 0% inclusive to 0.1% exclusive is given 1 point, and the probability ranging from 0.1% inclusive to 3% exclusive is given 2 points. In addition, the probability ranging from 3% inclusive to 6% exclusive is given 3 points, the probability ranging from 6% inclusive to 26% exclusive is given 5 points, and the probability of 26% or higher is given 10 points. The probability based on earthquakes having a seismic intensity of a higher 6 or higher may be used instead of the probability based on earthquakes having a seismic intensity of a lower 6 or higher. At any rate, the probability that earthquakes will occur at the locations is converted in a scale of maximum 10 points.

Numbers of points about floods, landslide disasters, and tsunami are calculated using “Overlapping hazard maps—a free risk information check” provided at a hazard map portal site (https://disaportal.gsi.go.jp/) run by Ministry of Land, Infrastructure, Transport, and Tourism, for example. With respect to floods, for example, if the location of a fabrication place or a storage place falls into an expected flooded zone (expected maximum scale) that is expected to be flooded due to an overflowing river, then a number of points are given depending on the depth of water in the zone.

For example, in case there is no flooding, i.e., the depth of water is 0.0 m, 0 point is given. In case the depth of water in the zone is larger than 0.0 m and smaller than 0.3 m, 1 point is given. In case the depth of water in the zone is 0.3 m or larger and smaller than 0.5 m, 2 points are given. In case the depth of water in the zone is 0.5 m or larger, 10 points are given. The relatively large number of points are given in case the depth of water in the zone is 0.5 m or larger, because a semiconductor manufacturing apparatus are generally large in size and weight and are relatively frequently installed on the first floor of a building.

With respect to landslide disasters, 5 points are given if the location of a fabrication place or a storage place is in (1) a landslide warning zone on a steep slope, (2) a debris flow warning zone, or (3) a landslide warning zone. Furthermore, 10 points are given if the location of a fabrication place or a storage place is in (4) a landslide special warning zone on a steep slope, (5) a debris flow special warning zone, (6) a landslide special warning zone, near (7) a mountain stream in danger of debris flows, falls into (8) a site in danger of a landslide on a steep slope, (9) a site in danger of a landslide, or (10) a site in danger of avalanches.

By contrast, 0 point is given in case the location of a fabrication place or a storage place does not fall into any of (1) through (10) referred to above. With respect to tsunami, points are given depending on the depth of water in a zone if the location of a fabrication place or a storage place is in a zone that is expected to be flooded due to tsunami (expected maximum scale). As with floods, relatively large numbers of points are given in case the depth of water is 0.5 m or larger. For example, in case there is no tsunami, i.e., in case the depth of water is 0.0 m, no point is given. In case the depth of water in the zone ranges from 0.01 m inclusive to 0.5 m exclusive, 2 points are given. In case the depth of water in the zone ranges from 0.5 m inclusive to 1.0 m exclusive, 5 points are given. In case the depth of water in the zone is 1.0 m or larger, 10 points are given.

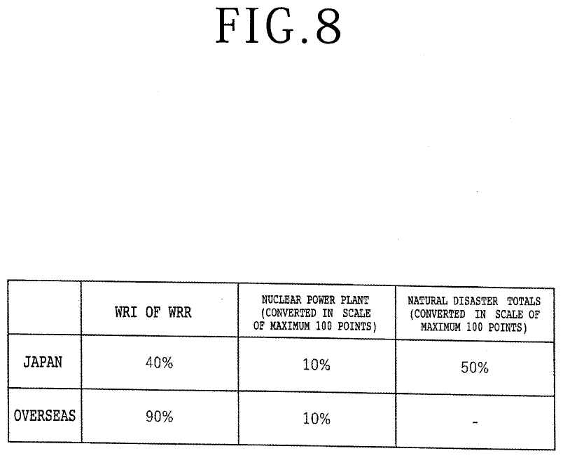

The numbers of points in a scale of maximum 40 points with respect to earthquakes, floods, landslide disasters, and tsunami are listed in a column of natural disaster totals, and the numbers of points of the natural disaster totals in the scale of maximum 40 points are converted in a scale of maximum 100 points and listed in a column on the right side of the column of natural disaster totals. In case the locations of fabrication places and storage places are in Japan, as illustrated in FIG. 8, the total of 40% of WRI of WRR, 10% of nuclear power plants (the number of points converted in a scale of maximum 100 points), and 50% of natural disaster totals (the number of points converted in a scale of maximum 100 points) is used as a (domestic) total number of points 52b (S24 in FIG. 10).

FIG. 8 illustrates proportions of WRI of WRR, nuclear power plants (the number of points converted in a scale of maximum 100 points), and natural disaster totals (the number of points converted in a scale of maximum 100 points) in the total numbers of points 52b of procurement risks representing geographical factors. The proportion of the natural disaster totals is of a relatively large value of 50% in case the locations are in Japan because domestic information is more detailed than overseas information and hence is considered to reflect more accurate facts.

In contrast, in case the locations of fabrication places and storage places are overseas, not in Japan, as illustrated in FIG. 8, the total of 90% of WRI of WRR and 10% of nuclear power plants (the number of points converted in a scale of maximum 100 points) is used as a (overseas) total number of points 52b (S24 in FIG. 10). As it is difficult to obtain detailed predicted values for the respective locations from overseas countries like risks of domestic earthquakes, floods, landslide disasters, and tsunami, assessments of these risks are replaced with WRR values. Therefore, the proportion of WRI is relatively large.

The sum of the total numbers of points 52a illustrated in FIG. 6 and the total numbers of points 52b illustrated in FIG. 7 is calculated to obtain total numbers of points of procurement risk in a scale of maximum 200 points (see FIGS. 9 and S26 in FIG. 10). Then, each of the total numbers of points of procurement risk is divided by a maximum total number of points of procurement risk (74.780 of A-2-1 in the example illustrated in FIG. 9), thereby calculating a procurement risk level coefficient 34a (S28 in FIG. 10). In this manner, procurement risk level coefficients 34a normalized such that their maximum value is 1 are calculated respectively with respect to the raw materials 22 or the partly finished products 24. FIG. 9 illustrates the procurement risk level coefficients 34a. FIG. 10 illustrates a sequence for calculating a procurement risk level coefficient 34a.

As illustrated in FIG. 1, the required inventory calculating system 2 has the procurement risk level coefficient calculating section 52. The procurement risk level coefficient calculating section 52 is implemented by a second program read from the memory 6 and executed by the processor, for example. The procurement risk level coefficient calculating section 52 calculates procurement risk level coefficients 34a in the manner described above on the basis of weights, risk levels (see FIG. 6), WRI, information as to whether there is a nuclear power plant or not, risks of natural disasters such as earthquakes (see FIG. 7) that have been input to the computer 4. The memory 6 further has a sixth area 34. The sixth area 34 stores the procurement risk level coefficients 34a calculated by the procurement risk level coefficient calculating section 52. Then, required inventories 58a (see FIG. 11) are calculated respectively with respect to the raw materials 22 or the partly finished products 24 on the basis of the product importance level coefficients 32a and the procurement risk level coefficients 34a.

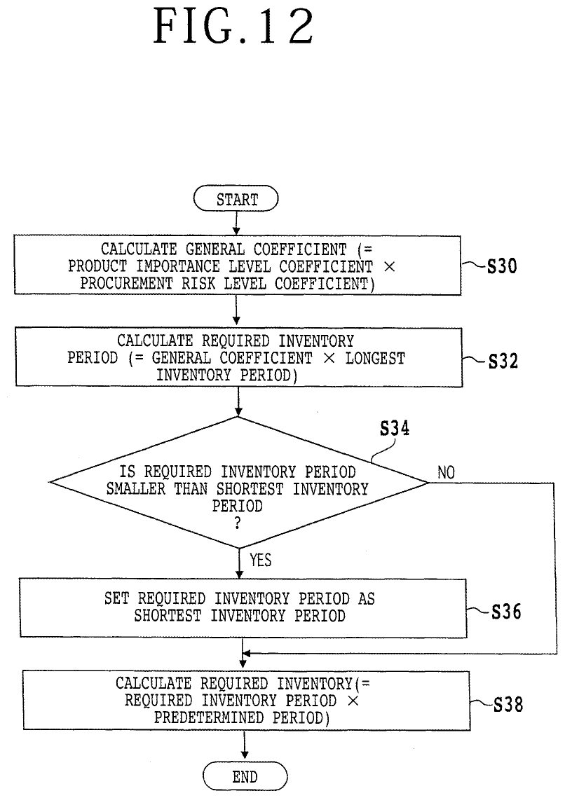

FIG. 11 illustrates required inventories 58a, and FIG. 12 illustrates a sequence for calculating a required inventory 58a. First, a general coefficient calculating section 54 (see FIG. 1) of the required inventory calculating system 2 calculates general coefficients 54a respectively with respect to the raw materials 22 or the partly finished products 24 by multiplying the product importance level coefficients 32a by the procurement risk level coefficients 34a (S30 in FIG. 12). The general coefficient calculating section 54 is implemented by a third program read from the memory 6 and executed by the processor, for example. Inasmuch as the product importance level coefficients 32a and the procurement risk level coefficients 34a according to the present embodiment have already been normalized such that their maximum value is 1, the general coefficients 54a normalized such that their maximum value is 1 are obtained by multiplying the product importance level coefficients 32a by the procurement risk level coefficients 34a.

However, general coefficients 54a may be calculated by multiplying coefficient multiplication values 44a (see FIG. 4) prior to being normalized as the product importance level coefficients 32a by total numbers of points of procurement risk (see FIG. 9) prior to being normalized as the procurement risk level coefficients 34a, and thereafter normalizing the products that have been obtained. The higher product importance level coefficients 32a are and the higher the procurement risk level coefficients 34a are, the higher the general coefficients 54a are. In other words, the higher the degree to which the raw materials 22 or the partly finished products 24 are needed by the customer 18a or the wholesaler 18b is and the higher the risk that the raw materials 22 or the partly finished products 24 cannot be procured is, the higher the general coefficients 54a are.

A required inventory period calculating section 56 (see FIG. 1) of the required inventory calculating system 2 calculates required inventory periods 56a respectively with respect to the raw materials 22 or the partly finished products 24 by multiplying the general coefficients 54a by a predetermined longest inventory period (S32 in FIG. 12). The required inventory period calculating section 56 is implemented by a fourth program read from the memory 6 and executed by the processor, for example. If a calculated required inventory period 56a is smaller than a predetermined shortest inventory period (YES in S34 in FIG. 12), then the calculated required inventory period 56a is set as the shortest inventory period (S36 in FIG. 12), i.e., the required inventory period 56a replaces the shortest inventory period.

In contrast, if a calculated required inventory period 56a is equal to or larger than the predetermined shortest inventory period (NO in S34 in FIG. 12), then the calculated required inventory period 56a is used as it is in a next step. According to the present embodiment, the predetermined longest inventory period represents 24 months. The predetermined longest inventory period of 24 months is determined in view of burdens such as costs imposed as the inventory of the product supplier 14 increases. According to the present embodiment, the predetermined shortest inventory period represents 6 months. The predetermined shortest inventory period reflects a period indicated to the customer 18a or the wholesaler 18b as a period in which the product supplier 14 is able to supply the products 12 at a certain supply rate to the customer 18a or the wholesaler 18b, for example.

Then, a required inventory calculating section 58 (see FIG. 1) of the required inventory calculating system 2 calculates required inventories 58a by multiplying the required quantities 30a of the raw materials 22 or the partly finished products 24 in the predetermined period, i.e., a 1 month according to the present invention, by the respective calculated required inventory periods 56a (S38 in FIG. 12). The required inventory calculating section 58 is implemented by a fifth program read from the memory 6 and executed by the processor, for example. According to the present embodiment, the calculated required inventories 58a are regarded as appropriate required inventories 58a of the raw materials 22 or the partly finished products 24 to be placed in the inventories of the produce supplier 14, and are stored in the required inventory calculating system 2 so as to be reflected in the commercial activities of the product supplier 14.

According to the present embodiment, since the required inventory calculating system 2 automatically calculates required inventories 58a of the raw materials 22 or the partly finished products 24 in the predetermined period, the required inventories 58a can be calculated with a smaller number of man-hours than if they are determined by a worker of the product supplier 14. Therefore, the required inventories 58a of the raw materials 22 or the partly finished products 24 can be calculated less costly than if they are determined by a worker of the product supplier 14.

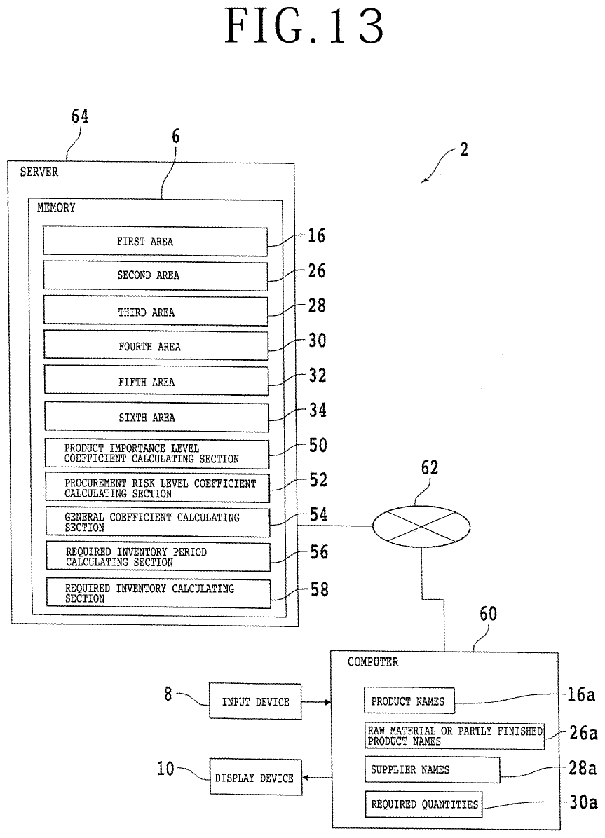

A required inventory calculating system 2 according to a second embodiment of the present invention will be described below. FIG. 13 illustrates in block form the required inventory calculating system 2 according to the second embodiment. According to the second embodiment, a computer 60 is connected to a server, i.e., a computer, 64 through the Internet 62 or a network. Each of the computer 60 and the server 64 has a processor and a memory. The computer 60 stores product names 16a, raw material or partly finished product names 26a, supplier names 28a, required quantities 30a, etc., and transmits the stored items of information to the server 64 through the Internet 62.

Predetermined programs stored in a memory of the server 64 are executed by a processor of the server 64, enabling the server 64 to function as the required inventory calculating system 2 that has a product importance level coefficient calculating section 50, a procurement risk level coefficient calculating section 52, a general coefficient calculating section 54, a required inventory period calculating section 56, and a required inventory calculating section 58 that are identical to those described above according to the first embodiment. Stated otherwise, various coefficients and items are calculated by the server 64, not the computer 60. On the basis of the information supplied from the computer 60, the server 64 calculates product importance level coefficients 32a and procurement risk level coefficients 34a, and also calculates general coefficients 54a, required inventory periods 56a, and required inventories 58a.

Information including the required inventories 58a is saved in a memory, not depicted, of the computer 60, which belongs to the product supplier 14, and is displayed on a display device 10. According to the second embodiment, the required inventories 58a of the raw materials 22 or the partly finished products 24 can be calculated less costly than if they are determined by a worker of the product supplier 14.

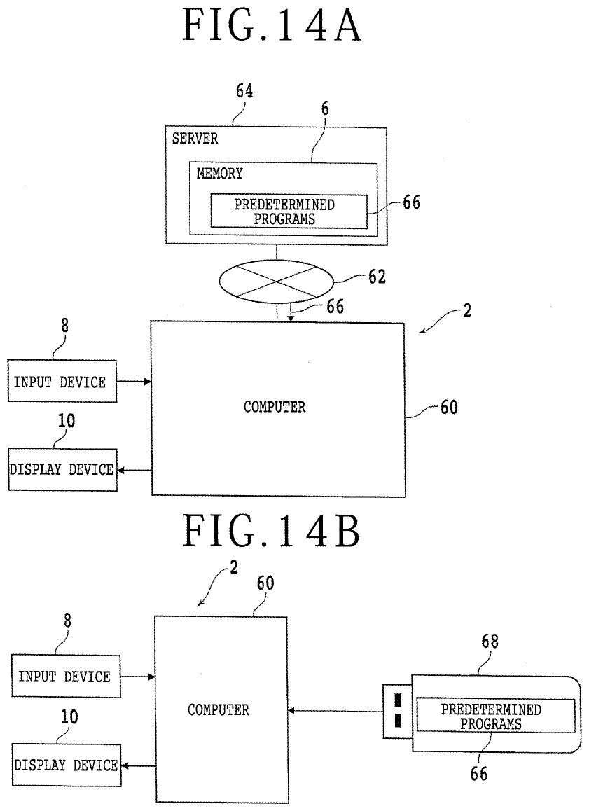

A required inventory calculating system 2 according to a third embodiment of the present invention will be described below. FIG. 14A illustrates in block form the required inventory calculating system 2 according to the third embodiment. According to the third embodiment, a server 64 stores predetermined programs 66 that enable a computer 60 to calculate product importance level coefficients 32a, procurement risk level coefficients 34a, general coefficients 54a, required inventory periods 56a, and required inventories 58a. The predetermined programs are provided from the server 64 via the Internet 62 to the computer 60, which belongs to the product supplier 14. The computer 60 functions as the required inventory calculating system 2 by reading the predetermined programs 66. According to the third embodiment, the computer 60 functions as the required inventory calculating system 2 that calculates product importance level coefficients 32a, procurement risk level coefficients 34a, general coefficients 54a, required inventory periods 56a, and required inventories 58a.

A required inventory calculating system 2 according to a fourth embodiment of the present invention will be described below. FIG. 14B illustrates in block form the required inventory calculating system 2 according to the fourth embodiment. According to the fourth embodiment, predetermined programs 66 are stored in a non-transitory computer-readable medium such as a USB memory 68. The computer 60 functions as the required inventory calculating system 2 by reading the predetermined programs 66 from the non-transitory computer-readable medium.

The structures, methods, etc. according to the above embodiments may be changed or modified appropriately without departing from the scope of the present invention.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A required inventory calculating system for calculating appropriate required inventories of raw materials or partly finished products to be procured from one or more suppliers and added to stock of a product supplier amidst commercial activities of the product supplier to procure at least either the raw materials or the partly finished products from the one or more suppliers, manufacture products therefrom, and supply the products to customers or wholesalers, the required inventory calculating system comprising:
a memory storing
names of the products,
names of the raw materials or the partly finished products from which the products are manufactured,
names of the one or more suppliers that supply the raw materials or the partly finished products, and
required quantities of the raw materials or the partly finished products required to supply the products to the customers or the wholesalers in a predetermined period;
a processor;
a product importance level coefficient calculating section for calculating product importance level coefficients established depending on an extent to which the products are needed by the customers or the wholesalers and representing respective levels of importance of the products;
a procurement risk level coefficient calculating section for calculating procurement risk level coefficients, respectively with respect to the raw materials or the partly finished products, established depending on a risk that the product supplier may not be able to procure the raw materials or the partly finished products from the one or more suppliers and representing the respective levels of procurement risk of the raw materials or the partly finished products;
a general coefficient calculating section for calculating general coefficients normalized such that their maximum value is 1 by multiplying the product importance level coefficients by the procurement risk level coefficients respectively with respect to the raw materials or the partly finished products;
a required inventory period calculating section for calculating required inventory periods respectively with respect to the raw materials or the partly finished products by multiplying the general coefficients by a predetermined longest inventory period, and, if the calculated required inventory periods are shorter than a predetermined shortest inventory period, setting the calculated required inventory periods as the shortest inventory period; and
a required inventory calculating section for calculating required inventories respectively for the raw materials or the partly finished products by multiplying the required quantities of the raw materials or the partly finished products in the predetermined period by the respective calculated required inventory periods.

2. The required inventory calculating system according to claim 1, wherein the product importance level coefficients are established such that the larger the quantities sold of the products in the predetermined period are, the higher numerical values represented by the product importance level coefficients are.

3. The required inventory calculating system according to claim 1, wherein
the product importance level coefficients include actual price coefficients, and
the actual price coefficients are established such that the higher an average value of actual prices of the products in the predetermined period is or the lower a discount ratio of the actual prices is, the higher the actual price coefficients are.

4. The required inventory calculating system according to claim 1, wherein the procurement risk level coefficients are calculated depending on risks of natural disasters at locations of places where the suppliers manufacture the raw materials or the partly finished products or places where the suppliers store the raw materials or the partly finished products.

5. The required inventory calculating system according to claim 1, wherein the procurement risk level coefficients are calculated in view of geographical factors of the suppliers including world risk indexes of a world risk report about countries of places where the suppliers manufacture the raw materials or the partly finished products or places where the suppliers store the raw materials or the partly finished products and information as to whether or not there is a nuclear power plant in the locations of the places where the suppliers manufacture the raw materials or the partly finished products or places where the suppliers store the raw materials or the partly finished products.

6. A program stored in a medium readable by a computer for enabling the computer, in calculating appropriate required inventories of raw materials or partly finished products to be procured from one or more suppliers and added to stock of a product supplier amidst commercial activities of the product supplier to procure at least either the raw materials or the partly finished products from the one or more suppliers, manufacture products therefrom, and supply the products to customers or wholesalers, the program comprising:
calculating product importance level coefficients established depending on an extent to which the products are needed by the customers or the wholesalers and representing respective levels of importance of the products;
calculating procurement risk level coefficients, respectively with respect to the raw materials or the partly finished products, established depending on a risk that the product supplier may not be able to procure the raw materials or the partly finished products from the one or more suppliers and representing the respective levels of procurement risk of the raw materials or the partly finished products;
calculating general coefficients normalized such that their maximum value is 1 by multiplying the product importance level coefficients by the procurement risk level coefficients respectively with respect to the raw materials or the partly finished products;
calculating required inventory periods respectively with respect to the raw materials or the partly finished products by multiplying the general coefficients by a predetermined longest inventory period, and, if the calculated required inventory periods are shorter than a predetermined shortest inventory period, setting the calculated required inventory periods as the shortest inventory period; and
calculating required inventories respectively for the raw materials or the partly finished products by multiplying the required quantities of the raw materials or the partly finished products in the predetermined period by the respective calculated required inventory periods.
